(19) United States
(12) Patent Application Publication
(10) Pub. No.: US 2003/0018836 A1
(43) Pub. Date: Jan. 23, 2003

(54) System and method for retrieving identification and capabilities information from computer long-term memory devices

(76) Inventors: Steven Bress, Germantown, MD (US); Mark Joseph Menz, Folsom, CA (US)

Correspondence Address: Steven Bress, 7851-C Beechcraft Avenue, Gaithersburg, MD, 20879, US

(21) Appl. No.: 10/197,370

(22) Filed: Jul. 17, 2002

Related U.S. Application Data
(60) Provisional application No. 60/306,492, filed on Jul. 19, 2001.

(51) Int. Cl. G06F 3/00

(52) U.S. Cl. 710/16

(57) ABSTRACT

An application specific device for retrieving identification and capabilities information from a long-term storage device includes a power supply, a control circuit, and an interface to the storage device. The control circuit controls the long-term storage device to retrieve identification and capabilities information data from the storage device. The storage device may be, for example, a hard disk drive or compact flash memory. The application specific device is physically small, is operating system independent, and has simple interface that is useable by non-computer professionals.

### RELATED APPLICATION

This application claims priority under 35 U.S.C. §119 based on U.S. Provisional Application No. 60/306,492, filed Jul. 19, 2001, the disclosure of which is incorporated herein by reference.

### BACKGROUND OF THE INVENTION

A. Field of the Invention

The present invention relates to computer memory devices and, more specifically, to mechanisms for retrieving identification and capabilities information from memory devices.

B. Description of Related Art

Externally computer hard drives are physically similar. Every hard drive is manufactured with a unique identification number. This identification number is electronically stored on the hard drive. In addition, this identification number may be on a label externally affixed to the hard drive. This label may be removed from the hard drive. This label is also vulnerable to tampering. Law enforcement agencies require an accurate unique identification number to ensure chain of custody. Security organizations require an accurate unique identification number to track hard drives with sensitive and/or classified information on them.

Internally, computer hard drives vary greatly. Hard drive size, number of tracks, number of sectors, number of cylinders are examples of drive capabilities of interest to users. This information is electronically stored on the hard drive. In addition, this information may be on a label externally affixed to the hard drive. This label may be removed and/or inaccurate.

Computer hard drives are often recycled. For example, some users replace their long-term memory storage devices for larger and/or faster devices. A graphic artist may need a bigger/faster long-term memory storage device than say a writer. While a device may no longer have value to the graphic artist, the writer may find value in that device. Some users routinely replace their entire functioning computer, which includes one or more long-term memory storage devices. These replaced computers will often have value. However, in order to be able to efficiently reuse these long-term memory storage devices, it is desirable to first obtain accurate information about their capabilities.

A conventional software method of retrieving identification and capabilities information from computer long-term memory devices is by connecting a long-term memory device to a working standard computer (PC) operating system and querying the device. There are a number of potential problems with this approach. First, an expensive PC must be taken from productive service, along with the desk space needed to support its keyboard, monitor and mouse. Second, a trained user must attach the target drive to the host machine. During this process, the host machine must be shut down, the target drive properly installed, and configured with a valid address or master/slave status, and finally the host machine rebooted. This can be a time consuming process requiring a trained user. Finally, there is a potential system problem. Most PCs are not designed for hard drives being swapped in an out on a regular basis. A static charge, or cable failure while installing a target drive can damage not only the target drive but also the host machine.

The above-mentioned system has the potential for changing long-term memory. The simple act of connecting a hard drive to a computer may cause the computer to write information to the drive, thus altering it. In computer forensic applications, a hard drive may not be altered at all.

A hardware method for identifying hard drive unique identification numbers uses specially manufactured hard drives with a radio frequency tagging system that enables a user to read the identification remotely. This method has obvious uses in security applications. However, as it requires specially manufactured hard drives it has limited applications.

Accordingly, there is a need in the art to more efficiently retrieve identification and capabilities information from long-term memory devices such as hard drives.

### SUMMARY OF THE INVENTION

Systems and methods consistent with the principles of this invention provide for an easy to use and portable long-term identification and capabilities information retrieval device.

One aspect of the invention is directed to a device for retrieving identification and capabilities information from a long-term memory component. The device includes an interface for connecting the device to the long-term memory component and a control circuit configured to query the long-term memory component through the interface to retrieve identification and capabilities information from the long-term memory component. A user controllable switch, when actuated by a user, causes the control circuit to commence a query from the long-term memory component. The device includes a communication interface configured to display the results of this query to a user.

A method consistent with aspects of the invention includes connecting a power supply to a query device, connecting a cable associated with the query device to a long-term memory component in a computer, and powering-up the computer. The method further includes activating the query device via a switch attached to the query device, retrieving identification and capabilities information from the long-term memory component, signaling completion of identification and capabilities information retrieval, and communicating this information.

Another method consistent with aspects of the invention includes connecting a power supply to a query device, connecting a cable associated with the query device to a long-term memory component, and connecting a power cable attached to the query device to the long-term memory component. The method further includes activating the query device via a switch attached to the query device, retrieving identification and capabilities information from the long-term memory component, signaling completion of identification and capabilities information retrieval, and communicating this information.

Yet another aspect of the invention is directed to a device for retrieving identification and capabilities information from a long-term memory component. The device includes LEDs configured to provide feedback relating to an operational status of the device to a user, a user settable switch, a communication interface to display the retrieved identification information to a user, and a long-term memory interface for connecting to a long-term memory component. The device further includes circuitry coupled to the LEDs, the user settable switch, the communication interface, and the long-term memory interface, the circuitry configured, when the switch is actuated by the user, to communicate with the long-term memory component through the interface and query the long-term memory component to retrieve identification and capabilities information therefrom, and to communicate this retrieved information to a user through the communication interface. The circuitry is enclosed in a portable casing and the LEDs, the user controllable switch, the communication interface and the long-term memory interface are mounted on an external portion of the casing.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a block illustration illustrating an identification and capabilities information retrieving device consistent with an aspect of the present invention;

FIG. 2 is a diagram illustrating portions of the query device shown in FIG. 1 in additional detail;

FIG. 3 is a diagram illustrating portions of the query device shown in FIGS. 1 and 2 in additional detail;

FIG. 4 is a diagram of an external view of an implementation of the query device;

FIG. 5 is a flow chart illustrating operation of the query device of FIG. 4 when querying a drive located within a host computer;

FIG. 6 is a diagram of external view of another implementation of the query device;

FIG. 7 is a flow chart illustrating operation of the query device of FIG. 6 when querying a detached drive; and

FIG. 8 is a flow chart illustrating operation of the query device consistent with an aspect of the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

A querying device for retrieving identification and capabilities information from long-term memory devices, such as hard drives, includes a host circuit that directs a target drive to return information to the host circuit. The query device is physically compact, is relatively simple to operate, and is operating system independent.

Storage devices discussed herein may be any type of long-term non-volatile memory device. For example, the storage device may be a hard disk drive or compact flash memory. In one implementation, the storage device uses an Integrated Drive Electronics (IDE) interface. An IDE interface is a well-known electronic interface that is frequently used to connect a computer's motherboard and disk drive.

Although concepts consistent with the present invention are primarily described herein in relation to an IDE magnetic hard disk drive, these concepts may be implemented with other types of IDE media, such as flash memory with an IDE interface. Flash memories are a special type of semiconductor random access memory that retains its data after power has been removed from the system. Other types of media useable with an IDE interface include magnetic tape. In addition to the IDE interface, concepts consistent with the invention may be applied in a straightforward manner to other types of high level storage interfaces, such as the well known Small Computer System Interface (SCSI) standard or a hard drive connected through an IEEE 1394 (Firewire) connection.

For the sake of clarity the remaining description herein will be described with reference to an IDE magnetic hard disk drive, although, as mentioned above, the concepts of the invention are not limited to such drives. One skilled in the art would appreciate that other modern long-term storage device interfaces share similar functionality that could be incorporated into the concepts described herein.

### QUERY DEVICE

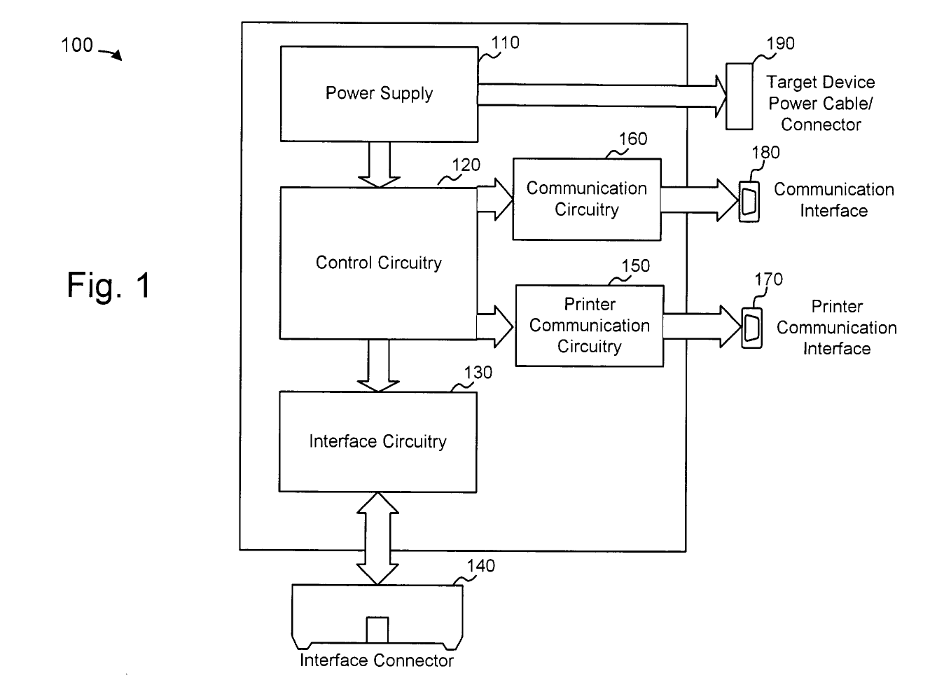

FIG. 1 is a block diagram illustrating a query device 100 consistent with an aspect of the present invention. Query device 100 includes power supply 110, control circuitry 120, interface circuitry 130, an interface connector 140, printer communication circuitry 150, and communication circuitry 160. Power supply 110 supplies power through a power cable connector 190, printer communication circuitry 150 may connect to a printer communication interface 170, and communication circuitry 160 may connect to a communication interface 180.

A hard disk drive or compact flash drive (target drive) attaches to interface connector 140. As will be described in more detail below, control circuitry 120 detects the type of the target drive and issues commands that result in identification information from the target drive being returned to the control circuitry. In other words, the target drive is “queried” by query device 100. Interface circuitry 130 passes instructions through connector 140 to the target device. Power supply 110 provides power to both control circuitry 120 and interface circuitry 130.

Printer communication circuitry 150 allows query device 100 to communicate with a host computer, such as a personal computer. Communication interface 170 may be a serial interface that may be connected to a personal computer. Printer communication circuitry 150 may then handle the serial communication protocols between the personal computer and querying device 100. Additionally instead of connecting to a personal computer, printer communication interface 170 may be used to interface directly to a stand-alone printer, through which query information may be output. Printer communication interface 170 is optional. In one implementation, query device is implemented as a stand-alone device with an lcd panel, or built-in printer used to communicate to a user rather than using a separate computer or printer.

Communication circuitry 160 allows query device 100 to communicate with a host computer, such as a personal computer. Communication interface 180 may be a serial interface that may be connected to a personal computer. Communication circuitry 160 may then handle the serial communication protocols between the personal computer and querying device 100. Additionally, instead of connecting to a personal computer, communication interface 180 may be used to interface directly to a stand-alone printer, through which status information may be output. Communication circuitry 160 and communication interface 180 are optional. In one implementation, query device is implemented as a stand-alone device that may be used to query hard drives without using a separate computer.

Query device 100 may be designed as a relatively small, lightweight, and easily portable device. In one implementation, querying device 300 is embodied in a case approximately 8″×10″×1.5″.

Power cables allow power to be supplied to the target disk drive through power connector 190. This allows query device 100 to process a target drive whether or not the target drive is still connected to a working computer or similar device (host).

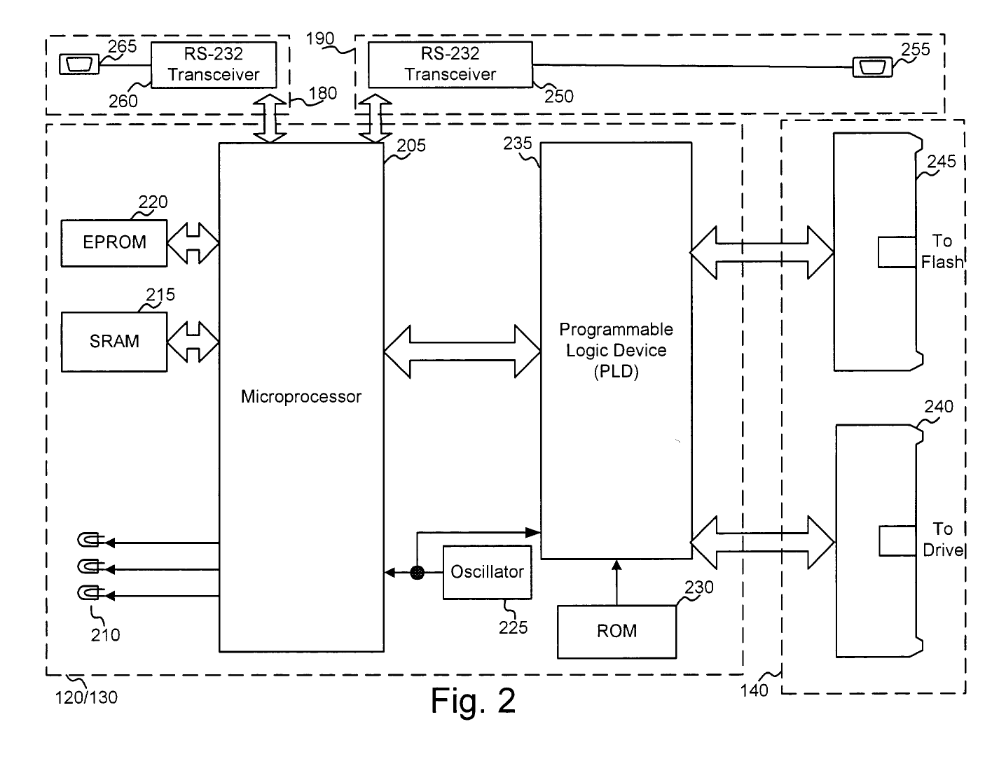

FIG. 2 is a diagram illustrating portions of query device 100 in additional detail. Control circuitry 120 and interface circuitry 130 of query device 100 includes microprocessor 205 and programmable logic device (PLD) 235. Microprocessor 205 may be an embedded processor, such as the 80386 EX embedded processor manufactured by Intel Corporation, of Santa Clara, Calif. The integrated design of microprocessor 205 allows relatively little additional circuitry to be used to create a small, dedicated computer system. PLD 235 complements microprocessor 205 by performing logical operations required by the microprocessor 205 or other circuitry of query device 100. ROM 230 stores configuration data that is initially loaded into PLD 235 on start-up. Similarly, EPROM 220 stores the initial code necessary to initialize and run microprocessor 205. Static RAM (SRAM) 215 is also connected to microprocessor 205, and is used for temporary program and data storage. Crystal oscillator 225 provides clocking signals to microprocessor 205 and PLD 235. In one implementation, crystal oscillator 225 generates a 50 MHz clock signal.

Microprocessor 205 may control external devices, such as LED status indicators 210. Through LED status indicators 210, microprocessor 205 may provide easily understandable feedback to a user. For example, one of LEDs 210 may be a green LED that is powered by microprocessor 205 when it finishes querying a drive. Alternatively, microprocessor 205 may cause an audible sound to be produced when it finishes querying a drive.

Interface 140 may include a hard drive interface 240. Drive interface 240 may be a standard IDE drive interface that connects query device 100 to the target drive. Interface 140 may also include a compact flash interface 245 which, in a similar manner, allows query device 100 to connect to and interrogate compact flash memory devices.

In addition to connecting to the target drive through interface circuitry 140, microprocessor 205 may be connected to external devices via RS-232 port 255 and RS-232 transceiver 250. RS-232 port 255 may be a standard DB9 connector that allows connections using a standard DB9 male to female serial cable.

In addition to connecting to the target drive through interface circuitry 140, microprocessor 205 may be connected to external devices, such as printers or other display devices, via RS-232 port 265 and RS-232 transceiver 260. RS-232 port 265 may be a standard DB9 connector that allows connections using a standard DB9 male to female serial cable.

One of ordinary skill in the art will recognize that the components shown in FIG. 2 may be selected from a wide variety of commercially available components. In one implementation, the components in FIG. 2 may be selected as follows: PLD 235, part number EP1K50QC208-2, available from Altera Corporation of San Jose, Calif.; ROM 230, part number EPC1PC8, available from Altera Corporation; EPROM 220, part number AT27LV020A90JC, available from Atmel Corporation, of San Jose, Calif.; and SRAM 215, part number CY7C1021V33L12ZCT, available from Cypress Corporation, of San Jose, Calif.

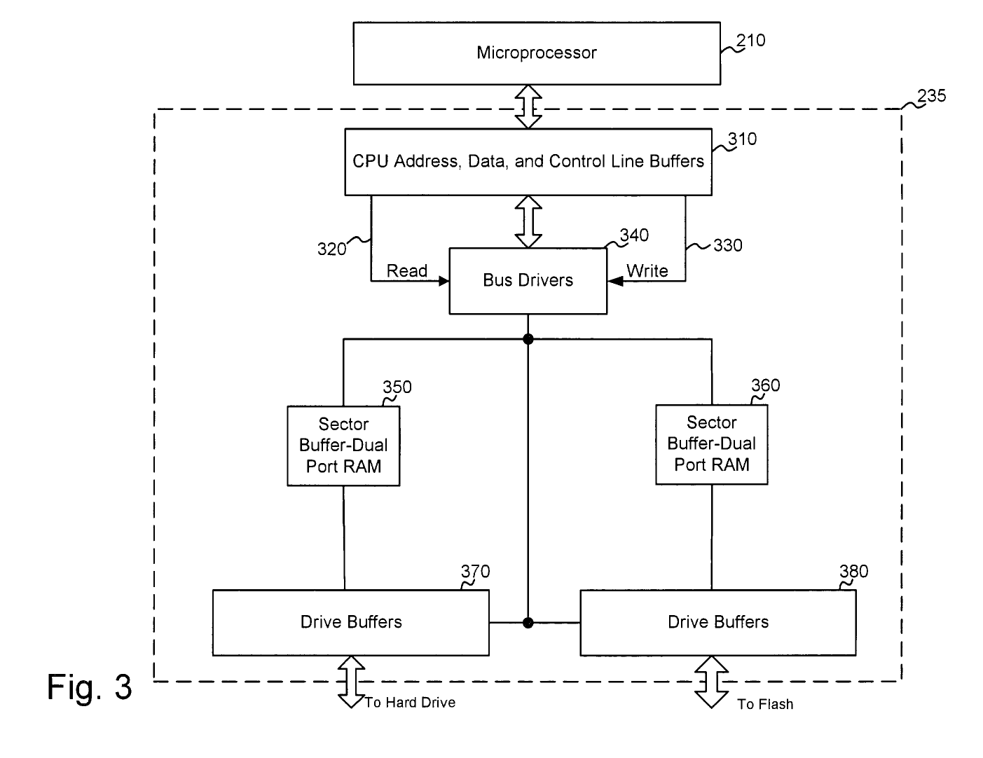

FIG. 3 is diagram that graphically illustrates the functionality of PLD 235 in additional detail. Address, data, and control lines from the microprocessor 205 are routed to PLD 235 where their information is buffered and latched as necessary in buffers 310. Buffers 310 serve to reduce the electrical load on the processor and to stabilize the signal timing. Buffer read and write signals 320 and 330 control the direction of the bus drivers 340. Thus, bus drivers 340 may write data into buffers 310 when read signal 320 is active and read data out of buffers 310 when write signal 330 is active. Buffers 310 and bus drivers 340 help control the data flow and distribution of the address and data buses from the microprocessor 205 to other portions of PLD 235.

Buffering and signal conditioning for the target disk drive is provided by drive buffers 370, which form the drive interface with the target disk drive. Buffering and signal conditioning for compact flash is provided by drive buffers 380, which form the interface with the compact flash. Through the bus drivers 340, the microprocessor 205 can directly read and write to the drive interface associated with the target disk drive and compact flash.

Instead of directly communicating with drive buffers 370 and 380, bus drivers 340 may indirectly communicate with drive buffers 370 and 380 through dual ported RAM sector buffers 350 and 360. Sector buffer 350 provides an additional layer of buffering between the microprocessor 205 and the disk drive and/or compact flash. This allows the target drive to write one sector's worth of data to RAM at high speed, while the microprocessor 205 reads a previous sector's worth of data. By allowing the operations to overlap in this fashion, the microprocessor 205 is not restricted to running at the speed of the target drive or compact flash, and is free to handle other functions until it needs the data in the sector buffers 350 or 360.

Referring back to FIG. 2, microprocessor 205 may include a UART that may be used for serial communications. Microprocessor 205 connects to RS-232 transceivers 250 and 260, which buffers the signals and generates the necessary voltages required for RS-232 communications. DB9 connector 255 and connects to a corresponding DB9 connector on a host device such as a personal computer. DB9 connector 265 and connects to a corresponding RS-232 connector on a device such as a printer. Although communication circuitry 150 and 160 are shown as implementing a serial connection, in other implementations, other types of connections, such as parallel or USB connections, may be used.

### OPERATION OF THE QUERY DEVICE

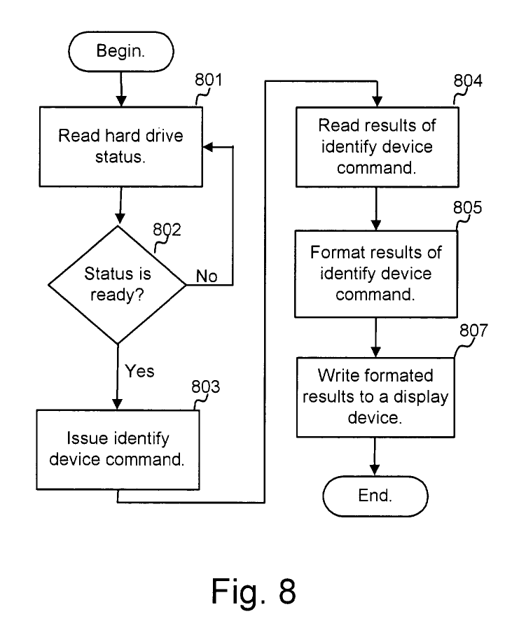

Query device 100 operates on a target drive inserted into interface connector 140 to retrieve identification and capabilities information of the drive. In general, query device 100 issues a command to a hard drive to return identification and capabilities information and then displays this information to a user. FIG. 8 is a flow chart illustrating operation of the query device (100) consistent with an aspect of the invention in additional detail. Query device 100 begins, through microprocessor 205 and PLD 235 by reading the hard drive's status bits (Act 801). When the status bits indicate the hard drive is ready (Act 802) query device issues an identify device command to the hard drive (Act 803). Query device reads the results of the identify device command (Act 804). These results are in the form of encoded bits. An IDE identify device packet is 256 words of data. One bit of those 256 words identifies a drive as “Big Drives Supported.” Query device translates the status of this bit from on/off to a more user-friendly term, such as Big Drives Supported/Big Drives Not Supported. Only a subset of the 256 words of an IDE identify packet are of interest to most users. This information must be formatted with additional characters such as hard-return characters. Query device translates and formats a subset of an IDE identity packet (Act 805). Query device writes this formatted/translated information through RS-232 transceiver 260 and connector 265 to a user display device (Act 807).

### EXTERNAL STRUCTURE AND OPERATION OF THE QUERY DEVICE

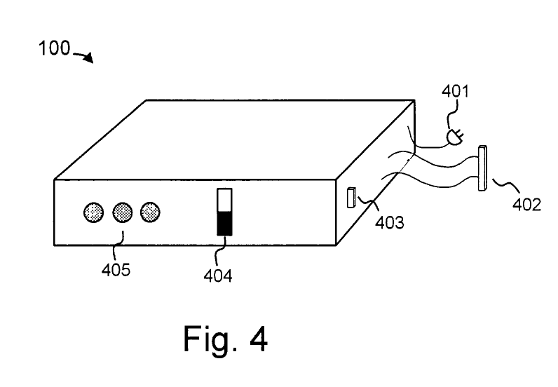

As previously mentioned, query device 100 may be constructed in a relatively small case, such as a case as small or smaller than 8.5″×10″×1.5″. FIG. 4 is a diagram illustrating an external view of one implementation of query device 100 consistent with an aspect of the invention.

As shown in FIG. 4, the external portion of query device 100 may include a power cord with a wall socket plug 401, an IDE drive cable 402 that is long enough to lead from query device 100 to a computer, a standard serial DB9 connector 403, an on/off switch 404, and LED status lights 405. Alternatively, query device 100 may include a battery compartment in place of or in combination with wall socket plug 401.

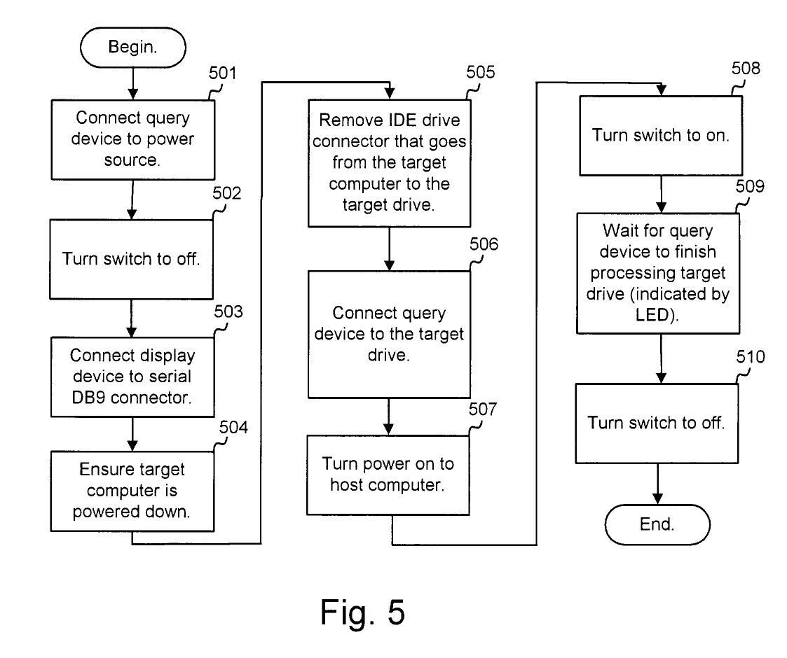

FIG. 5 is a flow chart illustrating operation of query device 100, as shown in FIG. 4, from the prospective of a user when querying a hard disk drive located within a host computer.

A user begins by connecting query device 100 to a power supply (Act 501) and ensuring that switch 404 is set to the “off” state (Act 502). In one implementation, this may involve plugging socket plug 401 into a wall power outlet. The user plugs a display device, such as a printer, into the standard serial DP9 connector (Act 503). The user also ensures that the computer system with the target disk drive is powered down (Act 504). The user may then remove any IDE cables that are in the target drive (Act 505). This may involve removing the cover of the host computer and removing the IDE drive connector that connects the host computer and the drive. The user may then connect IDE drive cable 402 to the drive, turn power on to the host computer, and turn switch 404 to the “on” position (Acts 506, 507, and 508). In response, query device 100 will power on and query the target drive to retrieve its identification and capabilities information. The querying may proceed as previously discussed with reference to FIG. 8. When query device 100 has finished querying the drive, it signals querying completion via LED status lights 405 (Act 509). For example, one of LED status lights 405 may flash on and off while query device 100 is operating. When query device 100 completes operating, the LED status light may remain steadily on. The user may then turn switch 404 to the “off” position and disconnect the query device from the host computer (Act 510).

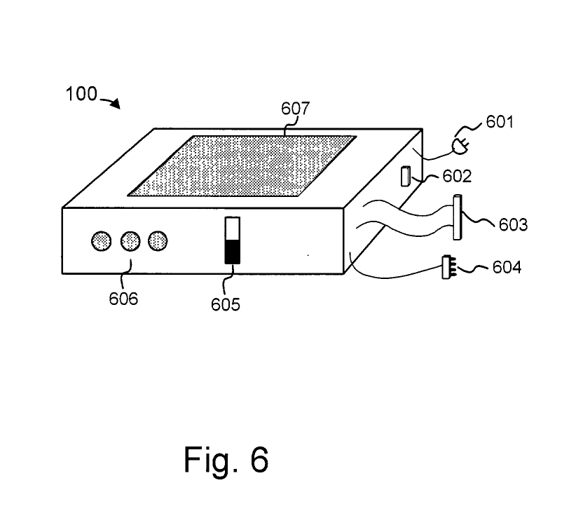

FIG. 6 is a diagram illustrating an external view of another implementation of query device 100 consistent with an aspect of the invention.

As shown in FIG. 6, the external portion of query device 100 may include a power cord with a wall socket plug 601, an IDE drive cable 603, an on/off switch 605, LED status lights 606, a drive power cord 604, a standard serial DB9 connector 602, and an anti-static cushion 607. A target drive may be placed on the anti-static cushion 607 and connected to the drive power cord 604 and the drive cable 604.

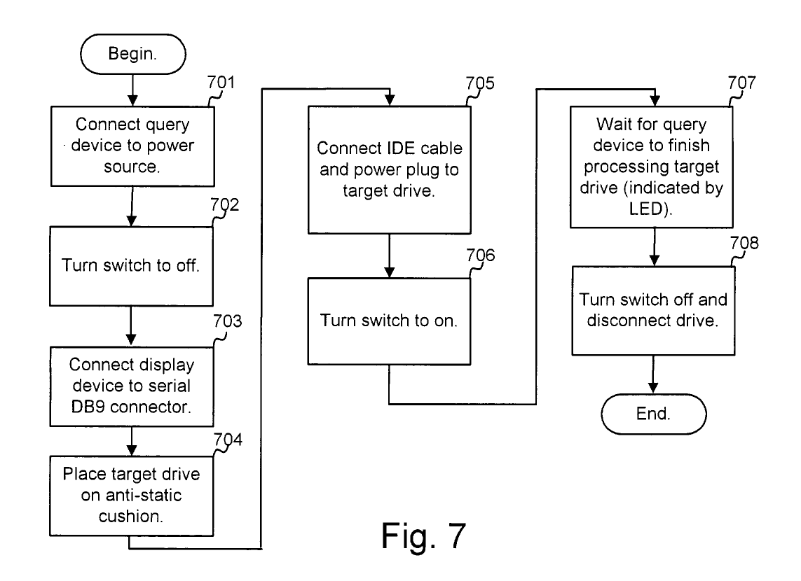

FIG. 7 is a flow chart illustrating operation of the query device 100, shown in FIG. 6, from the prospective of a user when querying a detached hard disk drive.

A user begins by plugging socket plug 601 into a power supply (Act 701) and ensuring that switch 605 is set to the “off” state (Act 702). The user plugs a display device, such as a printer, into the standard serial DB9 connector (Act 703). The target drive is then placed on the anti-static cushion 607, the IDE drive cable 603 plugged into the target drive, and the drive power cord 604 plugged into the target drive (Acts 704 and 705). The user may then turn switch 605 to the “on” position (Act 706). In response, query device 100 will power on and query the drive in a manner similar to that described above with respect to FIG. 8. When query device 100 has finished querying the drive, it signals querying completion via LED status lights 606 (Act 707). The user may then turn switch 605 to the “off” position and disconnect the query device and the target drive (Act 708).

As can be appreciated, the operation of query device 100, from the prospective of the user, is relatively simple. Accordingly, query device 100 can be operated by only moderately trained technicians. Additionally, the operation simplicity of query device 100 makes it unlikely that a user will improperly use the querying device in a manner that damages a disk drive.

### USER COMMUNICATION OF QUERY DEVICE STATUS

In the implementations described above, query device 100 signals its operational status to a user through LEDs 405 or 606. For example, LEDs may be used to signal that: (1) query device 100 is performing operations on a target device, (2) query device 100 has finished querying the target device, and (3) an error was encountered.

In alternate embodiments, query device 100 may include additional display devices such as a LCD graphical display, to communicate device status. With these output devices, additional status information such as percentage of operations complete, time until operations are complete, and information about the target device may be displayed.

### ADDITIONAL FEATURES

In the implementations described above, query device 100 has its level of data retrieval set in hardware. The identify device command returns a packet of 256 words. In the implementations described above only a subset of these 256 words are translated, formatted and displayed to a user. In an alternative embodiment, query device 100 may include an interface that a user can set to vary the information that is translated, formatted and displayed.

In yet another implementation, query device 100 could have a network interface to communicate with a display device. This network interface could in addition be used to allow a network pc to set what information is translated, formatted and displayed to a user, as discussed in the above paragraph.

Query device 100 issues an identification command to a target drive and then reads the result. If a target drive responds correctly to this identification command, a user may assume the target drive has some functionality. In additional embodiments, query device 100 may proceed, after querying the drive, to read various sectors on the drive to test the drive's functionality.

Although the query device discussed above was primarily described as querying an IDE device, in other implementations, long-term storage devices having other interfaces, such as FireWire, USB, USB2, or SCSI could be queried using concepts similar to those discussed herein.

### CONCLUSION

As described above, a query device retrieves identification and capabilities information from a target long-term memory device. The query device is portable, provides easy to understand user feedback, has a simple user interface and could thus be effectively used by non-technical people.

The query device has a number of advantages. It is operating system independent. The query device can operate while the target device is still in the host computer system or when it has been removed from the host computer system. It is a stand alone device that can replace more complicated and more expensive devices or systems. Additionally, the query device does not require that the operator have any particular knowledge of the target device.

Additionally, the query device can provide different levels of capabilities retrieval. The query device provides feedback to a user that it has either performed operations correctly or has run into an error.

It will be apparent to one of ordinary skill in the art that the embodiments as described above may be implemented in many different forms of software, firmware, and hardware in the implementations illustrated in the figures. The actual software code or specialized control hardware used to implement aspects consistent with the present invention is not limiting of the present invention. Thus, the operation and behavior of the embodiments were described without specific reference to the specific software code, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. Moreover, while a series of acts have been presented with respect to FIGS. 5, 7, and 8, the order of the acts may be different in other implementations consistent with the present invention. Moreover, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. A device for retrieving identification and capabilities information from a long-term memory component, comprising:
an interface for connecting the device to the long-term memory component;
a control circuit configured to query the long-term memory component through the interface to retrieve identification and capabilities information; and
a user controllable switch that, when actuated by a user, causes the control circuit to commence a query.

2. The device of claim 1, wherein the control circuit is a circuit dedicated to retrieving identification and capabilities information from the long-term memory component.

3. The device of claim 1, further comprising:
a casing configured to contain the control circuit and the interface, the user controllable switch being mounted on the casing, the casing being of a size that is portable by the user.

4. The device of claim 3, wherein the casing is a rectangular casing that is 8.5″×10″×1.5″ or smaller.

5. The device of claim 3, further comprising:
LED lights mounted on the casing and providing feedback relating to an operational status of the device to the user.

6. The device of claim 3, further comprising:
a cable emanating from the casing and connected to the interface, the cable being configured to connect to the long-term memory component.

7. The device of claim 3, wherein the cable is an Integrated Device Electronics (IDE) cable.

8. The device of claim 3, further comprising:
an anti-static pad positioned on an external side of the casing and configured to support the long-term memory component during identification and capabilities information from the long-term memory component.

9. The device of claim 1, further comprising:
a power supply configured to supply power to the control circuit.

10. The device of claim 9, further comprising:
a drive power cord emanating from the casing and configured to supply power from the power supply to the long-term memory component.

11. The device of claim 1, wherein the switch, when actuated by the user, causes the control circuit to commence retrieving identification and capabilities information from the long-term memory component.

12. The device of claim 1, wherein the specific capabilities of a long-term memory component's capabilities shown to a user is configurable.

13. The device of claim 1, wherein the control circuit verifies functionality of the long-term memory component after performing a query.

14. The device of claim 3, further comprising:
an interface mounted on the casing which a user may attach a display device for viewing the retrieved identification and capabilities information.

15. A method of retrieving identification and capabilities information by a query device from a long-term memory component installed in a computer, the method comprising:
connecting a cable associated with the query device to the long-term memory component in the computer;
powering-up the computer;
activating the query device via a switch attached to the query device;
querying the long-term memory component; and
signaling completion of the query from the long-term memory component.

16. The method of claim 15, wherein the long-term memory component is a disk drive.

17. The method of claim 15, wherein signaling completion of the query is performed via one or more light emitting diodes (LEDs).

18. The method of claim 15, wherein the specific capabilities of a long-term memory component's capabilities shown to a user is configurable.

19. The method of claim 15, wherein the retrieved identification and capabilities information are viewable by a user.

20. A method of retrieving identification and capabilities information from a long-term memory component, the method comprising:
connecting a cable associated with the query device to the long-term memory component;
connecting a power cable attached to the query device to the long-term memory component;
activating the query device via a switch attached to the query device;
retrieving identification and capabilities information from the long-term memory component; and
signaling completion of the query from the long-term memory component.

21. The method of claim 20, wherein the long-term memory component is a disk drive.

22. The method of claim 20, wherein signaling completion of the data removal includes illuminating one or more light emitting diodes (LEDs).

23. The method of claim 20, wherein the specific capabilities of a long-term memory component's capabilities shown to a user is configurable.

24. The method of claim 20, wherein the retrieved identification and capabilities information are viewable by a user.

25. A device for retrieving identification and capabilities information from a long-term memory component, comprising:
means for providing feedback relating to an operational status of the device to a user;
a user settable switch;
an interface for connecting to the long-term memory component; and
circuitry coupled to the means for providing feedback, the user settable switch, and the interface, the circuitry configured, when the switch is actuated by a user, to communicate with the long-term memory component through the interface and retrieve identification and capabilities information therefrom,
wherein the circuitry is enclosed in a portable casing, and the user settable switch and the interface are mounted on an external portion of the casing.

26. The device of claim 25, further comprising:
an anti-static pad positioned on an external portion of the casing and configured to support the long-term memory component during retrieval of identification and capabilities information from the long-term memory component.

27. The device of claim 25, further comprising:
a power supply configured to supply power to the circuitry; and
a drive power cord emanating from the casing, the drive power cord receiving power from the power supply.

28. The device of claim 25, wherein the casing is a rectangular casing that is 8.5″×10″×1.5″ or smaller.

29. The device of claim 25, wherein the interface is an Integrated Device Electronics (IDE) interface.

30. The device of claim 25, wherein the circuitry includes an embedded microprocessor.

31. The device of claim 25, wherein the circuitry retrieves identification and capabilities information of the long-term memory component by querying the component.

32. The device of claim 25, wherein the circuitry includes a user display interface.

33. A system comprising:
means for interfacing with a hard disk drive;
means for providing power to the hard disk drive; and
switching means for initiating retrieval of identification information and capabilities from the hard disk drive.

34. The system of claim 33, wherein the system is operating system independent relative to the hard drive.

34. The system of claim 33, wherein the hard disk drive is an Integrated Drive Electronics (IDE) disk drive.

35. The system of claim 33, wherein there are means for displaying the retrieved identification and capabilities information.
